(19) United States
(12) Patent Application Publication
(10) Pub. No.: US 2014/0034501 A1
(43) Pub. Date: Feb. 6, 2014

(54) METHOD AND AN APPARATUS TO REMOVE IONS

(71) Applicant: VOLTEA B.V., Sassenheim (NL)

(72) Inventors: Albert VAN DER WAL, Oegstgeest (NL); Bart VAN LIMPT, Leiden (NL); Hank Robert REINHOUDT, Wassenaar (NL); Pieter Maarten BIESHEUVEL, Wageningen (NL)

(21) Appl. No.: 13/957,137

(22) Filed: Aug. 1, 2013

(30) Foreign Application Priority Data
Aug. 2, 2012 (NL) 2009267

(51) Int. Cl. C02F 1/469

(52) U.S. Cl. CPC C02F 1/4691
USPC 204/555; 204/661

(57) ABSTRACT

A method of operating an apparatus to remove ions, the method including allowing water to flow in between a first and a second electrode of a capacitor, charging the capacitor with an electrical charge via a controller in order to attract ions into the electrodes; and releasing ions from the electrodes by releasing electrical charge from the capacitor via the controller. During a subsequent charging step, charging of the capacitor may be controlled with the controller by applying an electrical charge which does not substantially exceed a quantity of electrical charge released from the capacitor during the releasing of ions to keep the capacitor in balance.

### FIELD

The present invention relates to a method and an apparatus to remove ions from water.

### BACKGROUND

In recent years one has become increasingly aware of the impact of human activities on the environment and the negative consequences this may have. Ways to reduce, reuse and recycle resources are becoming more important. In particular, clean water is becoming a scarce commodity. Therefore, various methods and devices for purifying water have been published.

A method for water purification is by capacitive deionization, using an apparatus provided with a flow through capacitor (FTC) to remove ions in water. The FTC functions as an electrically regenerable cell for capacitive deionization. By charging electrodes, ions are removed from an electrolyte and are held in electric double layers at the electrodes. The electrodes can be (partially) electrically regenerated to desorb such previously removed ions without adding chemicals.

The apparatus to remove ions comprises one or more pairs of spaced apart electrodes (each pair of electrodes comprising a cathode and an anode) and a spacer, separating the electrodes and allowing water to flow between the electrodes. The electrodes may have current collectors or backing layers and a high surface area material, such as e.g. carbon, which may be used to store removed ions. The current collectors may be in direct contact with the high surface area material. Current collectors are electrically conductive and transport charge in and out of the electrodes and into the high surface area material.

A charge barrier may be placed adjacent to an electrode of the flow-through capacitor. The term charge barrier refers to a layer of material which is permeable or semi-permeable for ions and is capable of holding an electric charge. Ions with opposite charge as the charge barrier charge can pass the charge barrier material, whereas ions of similar charge as the charge of the charge barrier cannot pass or only partially pass the charge barrier material. Ions of similar charge as the charge barrier material are therefore contained or trapped either in e.g. the electrode compartment and/or in the spacer compartment. The charge barrier is often made from an ion exchange material. A charge barrier may allow an increase in ionic efficiency, which in turn allows energy efficient ion removal.

### SUMMARY

A problem with such an apparatus is that the capacity of the apparatus to remove ions from water may decrease over time.

Accordingly, it is desirable, for example, to provide an improved method of operating an apparatus to remove ions from water, the method comprising allowing water to flow in between a first and a second electrode of a capacitor; charging the capacitor with an electrical charge via a controller in order to attract ions into the electrodes; and releasing ions from the electrodes by releasing electrical charge from the capacitor via the controller.

According to an embodiment, there is provided a method of operating an apparatus to remove ions from water, the method comprising:

allowing water to flow in between a first and a second electrode of a capacitor;

charging the capacitor with a substantially constant electrical charge per unit time via a controller in order to attract ions into the electrodes;

releasing ions from the electrodes with a substantially constant electrical charge per unit time by releasing electrical charge from the capacitor via the controller, and during a subsequent charging of the capacitor, controlling the charging of the capacitor with the controller by applying an electrical charge which does not substantially exceed an amount of electrical charge released from the capacitor during releasing of ions from the electrode; and

measuring or calculating a quantity of electrical charge released from the capacitor and the amount of electrical charge charged to the capacitor with the controller.

By applying a charge during charging which does not substantially exceed an amount of electrical charge released from the capacitor during the releasing of ions there is no charge build up on the capacitor over time. A controller will be used to measure or calculate a quantity of electrical charge released from the capacitor and the amount of electrical charge charged to the capacitor to control the charging the capacitor and releasing of the ions. The performance of the apparatus may therefore be more stable over time and the amount of ions removed from the water may be more constant over time.

By not substantially exceeding an amount of electrical charge released from the capacitor during the releasing of ions from the electrode may be meant that during the charging not more than 125%, not more than 110%, not more than 105%, or not more than 100% of the amount of electrical charge released from the capacitor during the releasing of ions from the electrode is applied. The performance of the apparatus will be kept more stable over time and the buildup of charge may be avoided.

According to a further embodiment, there is provided an apparatus to remove ions, the apparatus comprising:

a first and a second electrode forming a capacitor;

a spacer to separate the electrodes of the capacitor and to allow water to flow in between the electrodes; and

a controller configured to control charging and discharging of the capacitor, the controller constructed and arranged to charge the capacitor with a substantially constant charging current and/or discharge the capacitor with a substantially constant discharge current, calculate a quantity of electrical charge released from the capacitor during discharging of the capacitor, and control electrical charge stored on the capacitor during a charging of the capacitor to not substantially exceed an amount of electrical charge released from the capacitor during a preceding discharging of the capacitor.

### BRIEF DESCRIPTION OF THE FIGURES

Embodiments of the invention will be described, by way of example only, with reference to the accompanying schematic drawings in which corresponding reference symbols indicate corresponding parts, and in which:

FIG. 1 shows a schematic cross-section of an apparatus to remove ions;

FIG. 2a shows a detail enlargement of the stack 3 of FIG. 1;

FIG. 2b shows a detail of FIG. 1;

FIG. 3 shows the applied voltage and the outlet conductivity of a deionization process for two charge-ion release steps operated at a substantially constant current setting;

FIG. 4 shows the accumulated charge and the outlet conductivity of a deionization process for two charge-ion release steps at a substantially constant current setting;

FIGS. 5a and 5b show the applied voltage and the outlet conductivity of a deionization process for two charge-ion release steps at pre-set purify and ion release steps; and

FIG. 6 disclose a controller for use in the apparatus of FIG. 1 to control the charging and ion release according to an embodiment.

### DETAILED DESCRIPTION

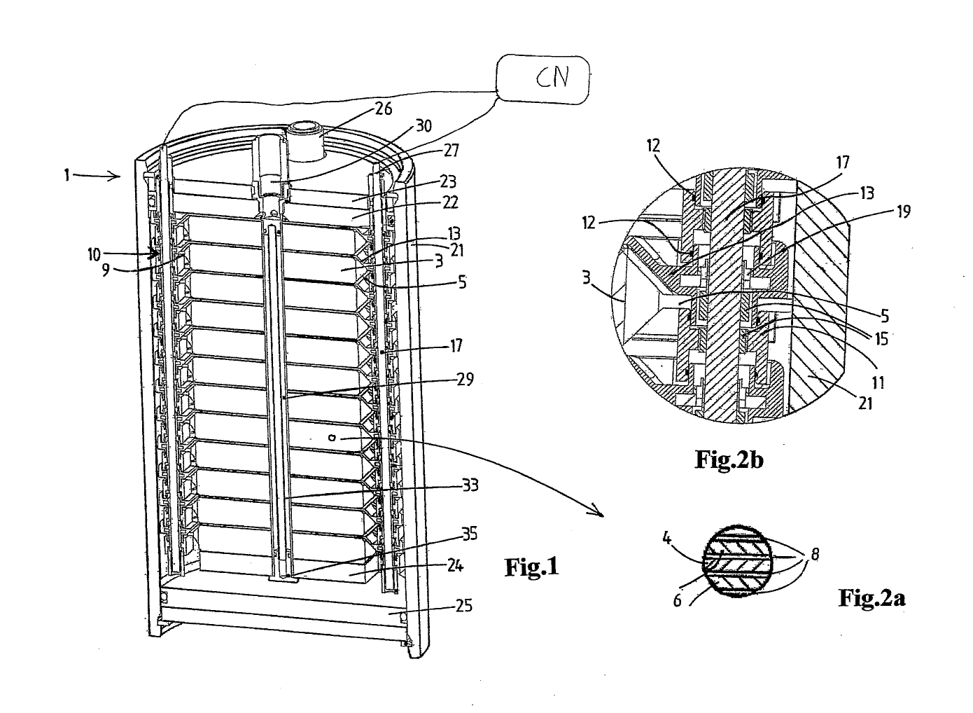

FIG. 1 shows a schematic cross-section of an apparatus to remove ions 1 with a part of the housing removed. In the example the apparatus may comprise twelve flow through capacitor stacks 3. The flow through capacitor stack 3 may comprise repeating units of a first electrode 4 (see FIG. 2a, which is an enlargement of a stack), a spacer 8, and a second electrode 6. The first electrode 4 may comprise a first current collector 5 (see FIG. 1), which may be bundled together with a first connector 11. The second electrode 6 may comprise a second current collector 9, which may equally be bundled together on the other side of the apparatus with the second connector 10.

The first connector 11 (see FIG. 2b, which is a partial enlargement of FIG. 1) may be used to clamp a plurality of first current collectors 5 together. The current collectors 5, 9 and the first connector 11 and the second connector 10 may be made of the same material e.g. carbon (e.g. graphite) to lower the electrical resistivity between the current collectors 5, 9 and the connectors 11, 10. The first connector 11 may comprise an insert 15 e.g. made from a metal, such as, for example copper. The insert 15 may be screwed in the first connector 11 so as to help assure low electrical resistivity between the insert 15 and the first connector 11. The power terminal 27 is a construction that is connected to both the power supply and one or more connectors 10, 11. The power terminal 27 may be fixed into the upper and/or bottom part 22, 24 and/or any other part of the housing. The power terminal 27 may comprise a rail e.g. rod 17 made of, for example, metal e.g. copper to electrically connect a plurality of the first connectors 11 via their inserts 15 to a power source (not shown). The first connector 11 and the insert 15 may have an opening for the rod 17. The inserts 15 and the rod 17 may be shielded from the water inside the apparatus by e.g. resin, glue or a paste which functions as a water barrier. The resin, glue or a paste or any other water shielding material may optionally be applied to the hollow part 19 of the connector 11 after compression of the stack. To help prevent the resin from contaminating the stack 3, a rubber ring 12 may be provided in the insert 15. A tray 13 may be provided to help manufacture one stack 3 and assembling a plurality of stacks 3 together in a housing 21 of the apparatus. Within the housing, the stacks 3 may be compressed between the top and bottom part 22, 24. The top part 23 of the housing 21 may have a feed-through allowing the rod 17 to make a connection with a power source. This way electrical charge can enter the first electrode via the first current collector 5 and also leave the electrode again, e.g. during regeneration of the electrodes. Water may be provided to an interior of the apparatus via a water inlet 26. The water is allowed to flow around the flow through capacitor stack 3 and may enter the stack via the spacer(s). The flow through capacitor stack 3 has a hole in the middle of the stack. In the hole, there is a circular tube 29 and via the space between the hole and the tube the water may flow to an outlet 30. The interior of the tube 29 may facilitate a nut 35 and threaded bar 33 which may help to compress the electrodes in the stack 3 and to compress the stack 3 between the upper and bottom part 22, 24 of the housing 21.

Compressing may occur during production of the apparatus, or optionally during maintenance. By compressing all the stacks at once it may be assured that the compression force is very similar or even equal for each stack and at the same time equally or homogeneously distributed over the surface of the electrodes.

During manufacturing of the stack 3, a first electrode comprising a first current collector 5 may be provided in the tray 13. A spacer may be located on top of the first electrode and a second electrode may be put on top of the spacer. Subsequently a spacer may be put on top of the second electrode followed by another first electrode. This may be repeated until, for example, 10 first and second electrode units are provided in the stack 3 held by the tray 13 with each first electrode separated from a second electrode by a spacer. Subsequently a connector part 11 may be located on top of the current collectors 5 and a metal insert 15 may be screwed from the other side of the stack 3 through the tray 13 and the first current collectors 5 to fix the stack 3 to the tray 13.

The tray 13 and the stack 3 may be connected to the rod 17 of the first power terminal 27 by sliding the insert 15 over the rod 17 to allow a good electrical contact. The hole in the insert 15 may be of such a size that it allows for good electrical contact between the insert 15 and the rod 17 and at the same time allowing the insert 15 to slide over the rod 17. The connector 11 may be pressed on the tray 13 with the current collector 5 or multiple current collectors 5 in between the connector 11 and the tray 13 by screwing of the insert 15 in the connector part 11. To help assure good electrical conductivity between the connector 11 and the first current collector 5, the pressure on the connector part 15 and the current collector may be less than 100 bar, less than 50 bar, less than 20 Bar or around 10 bar.

Multiple stacks 3 can be connected to the rod 17 and the stacks 3 may be connected in a similar way to the second connector 10. A force may be exerted on the stacks 3 with the nut 35 and threaded bar 33 via the upper and bottom part 22, 24 so as to compress the first and second electrode in a first direction substantially parallel to the length of the threaded bar 33 which is substantially perpendicular to the main surface of the electrode. The force may exert a pressure on the stack of less than 5 bar or less than 3 bar.

The first and second connector 11, 10 allow for movement of the first and second current collector 5, 9 along the rod 17, 18 in the first direction such that the current collectors are not damaged by the compression force on the stack 3. The movements may be in the order of 0.05 to 10% of the height of the multiple stacks 3 in the first direction. After enough pressure is exerted on the stack, a resin or grease may be provided along or through the first and/or second connector 11, 10 in the hollow parts 19 of the connectors 10, 11. The resin after hardening fixes the position of the connectors 10, 11 and may protect the (metal) inserts 15 and rod 17 from corrosion.

The apparatus may be operated with the following steps:

allowing water to flow in between a first electrode 4 and a second electrode 6 of a capacitor;

charging the capacitor with an electrical charge via a controller C in order to attract ions into the electrodes 4, 6; and

releasing ions from the electrodes by releasing electrical charge from the capacitor via the controller.

In order to obtain stable operation, it may be desirable for the apparatus to determine the moment to switch from charging the electrode to releasing ions from the electrode and vice versa. This switching may be controlled by the controller by:

1) Setting a limit to the maximum voltage. The controller may apply a pre-set electrical current of, for example, 5 amperes per stack. The voltage on the electrodes may be measured and the voltage for the charging step may be limited in order not to exceed a maximum value and the controller may switch to releasing ions from the electrodes once the maximum voltage is reached. Similarly, the voltage for the releasing ions step may not exceed a maximum (minimum) and the controller may switch to charging the electrodes again once the maximum voltage is reached or once a certain amount of charge has been released from the electrodes.

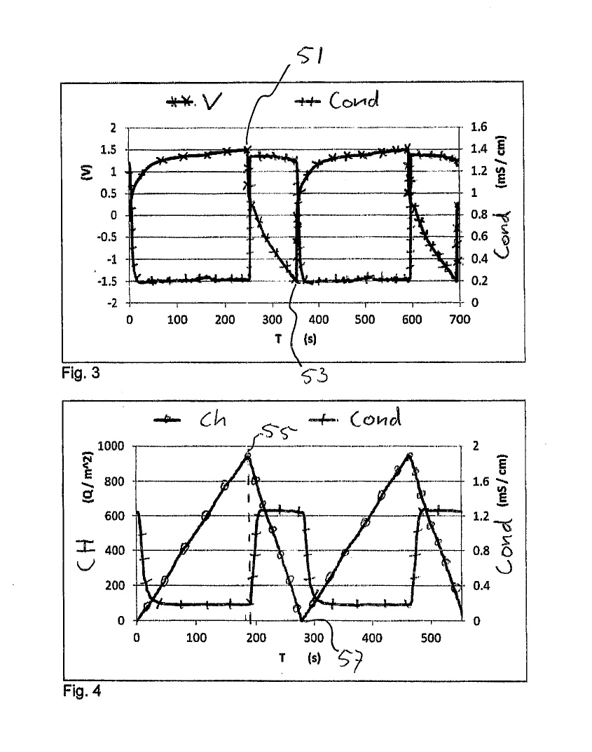

FIG. 3 shows the applied voltage and the outlet conductivity of a deionization process of two purify (ion removal from the water) and two ion release steps operated at a substantially constant current setting. Operating at a substantially constant current setting means that the controller adapts the voltage to keep the current substantially constant at, for example, 5 amperes per stack. In the purify step the electrodes are charging and ions are removed from the water leading to a lowering of the outlet conductivity of the water and an increase of the voltage during the purify cycle because of the charging of the electrodes. When a certain amount of electrical charge has been stored on the electrode or when the voltage reaches a certain value, e.g. 1.5 V, at 51 then the current is reversed by the controller to, for example, −5 amperes per stack and the ion release step starts. This results in an increase in the outlet conductivity as well as in a decrease of the measured voltage which can even become negative (for example, if a membrane is used). When a certain amount of charge has been released from the electrodes or when the measured voltage reaches a second maximum (minimum) 53, e.g. −1.5 V, the current is reversed again and the charging process restarts.

2) Fixed charge. The charging of the capacitor may be controlled with the controller by applying an electrical charge during the purify step which does not substantially exceed the amount of electrical charge released during the ion release step (electrode regeneration) or which is lower than or equal to the amount of electrical charge released from the capacitor during a previous ion release step.

FIG. 4 shows the accumulated charge on the electrodes and the outlet conductivity of a deionization process for two electrode charging and ion release steps. FIG. 4 shows that initially starting with t=0 seconds, the system is purifying, leading to a lowering of the outlet conductivity and an increase of the applied charge on the electrode. The current may be controlled by the controller in a substantially constant current mode, which leads to a linear increase of the charge with time (as shown in FIG. 4) or in a substantially constant voltage mode which leads to a non-linear increase of the charge with time (not shown).

In FIG. 4, the current is reversed after a pre-set time 55 after which the ion release step starts. However, it is also possible that the controller switches the current after a certain amount of charge has been accumulated on the electrodes. Again the current in the ion release step may be controlled in the substantially constant current or the substantially constant voltage mode by the controller. An increase in outlet conductivity and a decreasing accumulated charge on the electrodes is shown. When the accumulated charge reaches zero 57, or when a certain amount of charge has been released from the electrodes then the current is reversed again and the charging restarts.

3) Fixed timings. By setting the charging time and the time for ion release, the controller may switch from charging to ion release and vice versa at pre-set timings.

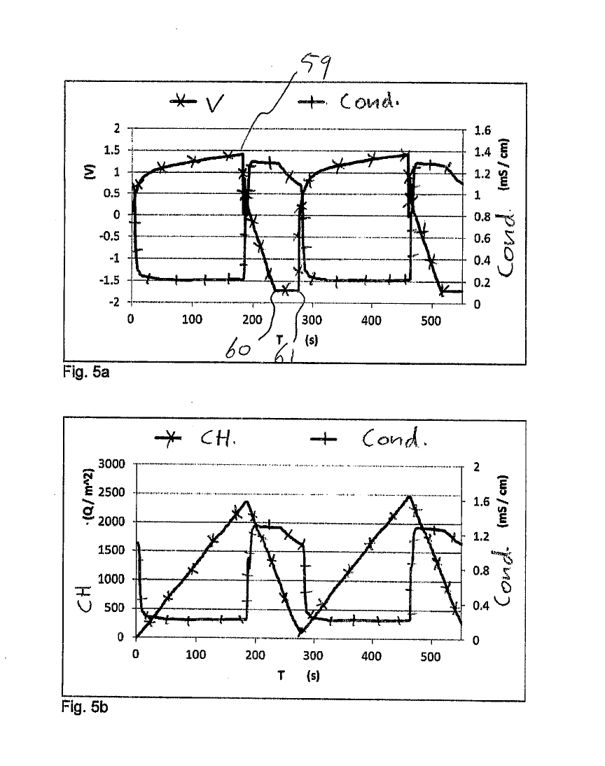

FIGS. 5a and 5b show the applied voltage and the outlet conductivity of a deionization process for two charge-ion release steps. Referring to FIG. 5a, initially, the system is charging with the controller charging the electrodes at substantially constant current. The outlet conductivity may be lowered and the applied voltage on the electrodes may be increasing because the controller increases the voltage on the electrodes in order to maintain the substantially constant current. When the time reaches a certain value 59, in this case 180 seconds, the current is reversed and the ion release step starts with the controller again maintaining the current substantially constant. This results in an increase in the outlet conductivity and an applied voltage that becomes more negative until the voltage reaches a minimum at 60 where the controller interferes to limit the voltage to a maximum at, e.g., −1.7 V. When the time reaches a second pre-set timing 61, in this case 270 seconds, the current may be reversed again and the charging may restart so that the controller may keep the current substantially constant.

FIG. 5b shows the accumulated charge and the outlet conductivity of a deionization process as described in FIG. 5a. In this example, the amount of charge that is released from the electrode in the ion release step is lower than the amount of charge applied during the purify step. This may lead to an unstable operation because the electrodes are not fully regenerated, and part of the electrical charge is still present in the electrodes, when the next purify step starts. As a consequence the desalination performance may decrease over time, because the electrodes can remove fewer ions from the water flowing in between the electrodes. It may be desirable that during the purify step no more charge is applied on the electrodes than the amount of charge that has been removed from the electrodes during the ion release step in order to maintain charge balance. The controller may decide to increase the amount of charge released from the electrodes during the ion release step by, for example, increasing the electrical current and/or the (maximum) voltage and/or the electrode regeneration time. Therefore applying an electrical charge during the purify step which is not exceed the amount of electrical charge released from the capacitor during a previous ion releasing step can help to enhance the stable operation of the system.

4) Combinations. The controller can also choose different combinations where part of the purify step or ion release step is controlled by a timer, or by a certain amount of electrical charge which is applied and released from the electrodes, such that the charging can be done at substantially constant current and/or at substantially constant voltage or partly in substantially constant current and substantially constant voltage mode. The controller can choose to charge the electrodes with the same amount of charge that was released during the ion release step of the previous cycle or take, for example, the average of a certain number of previous ion release steps.

Measuring or calculating an amount of electrical charge released from the capacitor and measuring or calculating the amount of electrical charge applied to the capacitor with the controller may be required in order to maintain a good balance to keep the capacitor in such a way that there isn't excess charge build up on the electrodes over time resulting in an unstable performance and reduced ion removal capacity of the system. The measured or calculated electrical charge may be compared with a reference electrical charge and the electrical voltage or electrical current applied to the capacitor may be adjusted in case the measured or calculated electrical charge is different from that of the reference electrical charge.

The charging step and the ion release step may be controlled by applying a substantially constant voltage (the electrical potential difference between the two porous electrodes). For example, during the charging step, a typical value of 1.2 V may be applied to attract ions and produce desalinated water, while during ion release, e.g. by short-circuiting the two electrodes, or by even reversing the cell voltage, ions may be released back into the spacer channel which results in a concentrated salt solution. Operation at a substantially constant cell voltage may however have as a disadvantage that the effluent salt concentration may change over time, e.g., the ion concentration in the desalinated water stream may increase during the charging step. This is because at the start of the charging step, the electrodes may still be mainly uncharged, and thus the driving force over the channel is at a maximum (no loss of voltage in the electrical double layer). Consequently, there may be a large ion flux directed towards and into the electrodes at the start of the charging step. Nevertheless, the ongoing ion adsorption in the electrical double layers during charging may lead to a gradual saturation of the electrodes and an increase of the voltage drop over the electrical double layer. As a consequence the remaining voltage across the spacer channel may steadily decrease in time. The overall effect may be that the effluent salt concentration (the salt concentration of the water flowing out of the cell) may first decrease, go through a minimum, and then gradually increase again.

The gradual change of effluent concentration over time may not be desired in practical applications. Instead, it may be more advantageous if water is produced of a substantially constant desalination level. To obtain an effluent stream with a substantially constant reduced salt concentration, it may be desirable to use a substantially constant current (CC) running between the two electrodes, instead of a substantially constant cell voltage (CV) applied over the electrodes. Under substantially constant current conditions, the capacitor may be charged with a substantially constant amount of electrical charge per unit time and/or the charge may be released from the capacitor with a substantially constant amount of electrical charge per unit time.

The externally applied substantially constant electrical current on the electrodes may translate into an equally large ionic current in the cell, which has contributions from the ionic flux of positive ions (such as Na⁺) and negative ions (such as Cl⁻). In a substantially constant current operation an effluent salt concentration may be kept substantially constant over time, during for example the charging step but also during the ion release step. An advantage of an operation using substantially constant current may be that the effluent concentration can be easily and accurately controlled at a certain level by varying the amount of electrical current going in and out of the electrodes. This may be advantageous from the viewpoint of the consumer who desires a fresh water supply with a substantially constant and tunable salt concentration. A further advantage of using a substantially constant current operation may be that it is more energy efficient because the voltage during the “first” ions that are attracted to the electrode may be lower compared to a substantially constant voltage operation so that the energy for ion removal, which is equal to the current * voltage, is lower.

The method may comprise measuring a voltage difference over electrodes of the capacitor with a voltage measurement device; and limiting the charging of the electrodes by controlling the voltage difference between the first and second electrodes so that the voltage difference does not exceed a pre-set threshold value. If the voltage difference is exceeding the threshold value, electrolysis may take place at one of the electrodes which may damage the electrode or could lead to an electrode imbalance. Time may be measured with a timer and the time together with the voltage difference may be used to obtain a representation of the voltage over time. The measured voltage over the capacitor as a function of time during the charging and the ion release steps may be registered and the voltage as a function of time may be registered in the memory of the controller. An actual measured voltage difference over the first and second electrodes of the capacitor as a function of time may be compared with the registered voltage difference as a function of time stored in the memory of the controller.

The amount of electrical charge released during the ion release step may be calculated from a measured current and the measured time during the ion release step. The amount of electrical charge that may be released from the capacitor during the ion release step may be registered in a memory of the controller. During charging of the capacitor in a subsequent charging step the amount of charge that is applied to the capacitor may not exceed or even be lower or equal than the amount of charge which has been registered in the memory of the controller. In this way it may be assured that not more charge is applied to the electrodes than may be discharged during the ion release step. This way the charge on the electrodes may be balanced during several charging and discharging (ion release) steps and hence the desalination performance of the system can be maintained over prolonged periods of time.

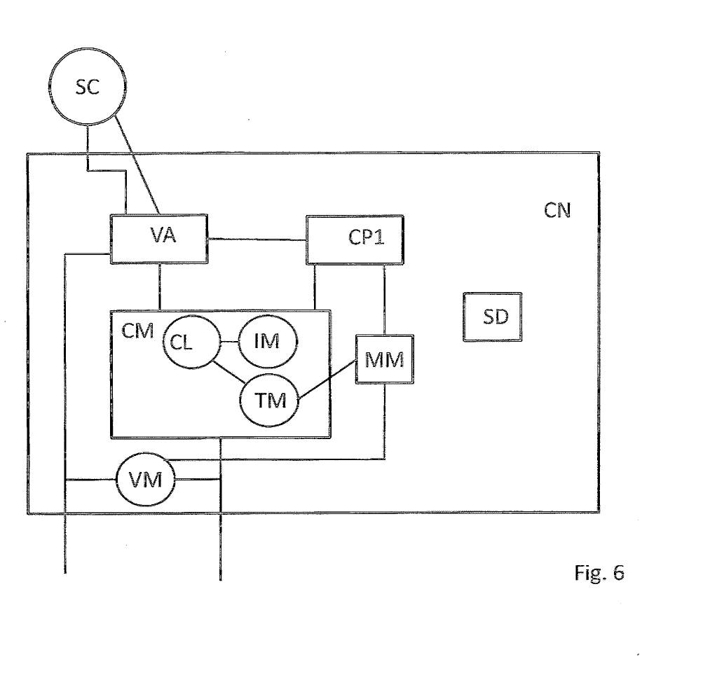

During charging of the capacitor, the controller CN (see FIG. 6) may be calculating the electrical charge with a charge measuring device CM by multiplying a measured current (measured with current measuring device IM) during charging with a measured time from a timer (TM) with calculator CL (see FIG. 6).

By integrating the current during charging with the time the charging took place the total charge applied to the capacitor may be calculated with calculator CL as well. During ion release, the current may be integrated with the time the ion release took place to calculate the total ions released from the capacitor.

By assuring that the charge supplied during charging is substantially equal to or less than the charge removed from the electrodes during discharging no charge will be left on the capacitor keeping the capacity of the capacitor to remove ions from the water during the purify steps substantially constant.

The controller may comprise a memory MM in which the amount of charge released during the ion release step is registered. This information may be used during the charging step to ensure that the amount of charge during charging does not exceed the electrical charge previously released. In case there is an imbalance between the electrical charge applied during charging and the registered amount of charge, which has previously been released from the electrode then an error signal may be generated.

The apparatus may comprise a controller CN configured to control the charging and discharging steps of the capacitor, wherein the controller is constructed and arranged to ensure that a certain amount of electrical charge is stored on the capacitor during a charging step which does not exceed the amount of electrical charge released from the capacitor during a preceding discharging step. The controller may be constructed and arranged to charge the capacitor with a substantially constant charging current and/or discharge the capacitor with a substantially constant discharge current. The controller CN may be connected to a power source SC.

To keep the current substantially constant the controller CN may have a current measurement device IM configured to measure an electrical current going into the electrodes. A processor CP1 may be used to compare the measured current with a reference current value stored in the memory MM (see FIG. 6). If the measured current is different from the reference current value then, for example, the voltage VA applied to the capacitor may be adjusted or the charging or discharging times may be adjusted or the charging or discharging current may be adjusted so that the measured current with the measurement device IM is equal to the reference current value.

The controller have a voltage measuring device VM configured to measure a voltage difference between the connecting lines to the electrodes, and a memory MM to store a voltage over time profile. The controller CN may be provided with the timer so as to compare the measured voltage as a function of the time with the stored voltage over time profile in the memory with the processor CP1.

For example, the stored voltage over time profile may be an ideal profile of the initial working of the apparatus. If, after a while, the actual voltage over time profile of the apparatus is much different than the stored voltage over time profile this may be an indication that a correction is required. The controller CN may comprise a signaling device SD configured to signal an error signal if the result of the comparison between the measured voltage as a function of time and the stored voltage over time is larger than a threshold value. The controller may be provided with a communication link to communicate with a remote maintenance service center. If an error is sent from the controller to the maintenance center then maintenance may be scheduled for the apparatus in the maintenance center.

The apparatus may be provided with a limiter to limit the voltage over the electrodes so that the voltage stays within a threshold range to help prevent that the potential difference over the electrodes becomes too high, which may lead to irreversible damage of the capacitor. For example, when the potential becomes too high electro-chemical reactions may occur at the electrodes. The limiter may be incorporated in the controller to allow that the voltage from a source SC stays within a maximum allowable voltage or may be a separate module.

### Electrode

The electrodes (anode and or the cathode) may be made metal free by making them from carbonaceous material, for example activated carbon, which may be bond together in a polytetrafluoroethylene (Teflon TM) matrix or carbon aerogel. The electrodes, which may be used in FTC cells may be treated with a concentrated salt solution to enhance the ion removal capacity of the electrodes as well as ion conductivity and hence the speed of removal. The electrodes may comprise a high surface area layer e.g. a porous carbon layer, which can be a flexible layer, or a non flexible layer.

The carbon used in the electrode layer may comprise activated carbon, and optionally any other carbonaceous material, such as carbon black, carbon aerogel, carbon nanofibres graphene or carbon nanotubes. The carbon may be chemically activated carbon or may be steam activated carbon. The carbon may have a high surface area of at least 500 m²/g, of at least 1000 m²/g, or of at least 1500 m²/g. The anode and cathode may be made out of different carbonaceous materials. Well known non-flexible carbon layers are made from carbon aerogel. The aerogel may be manufactured as resorcinol-formaldehyde aerogel, using pyrolysis. Depending on the density, carbon aerogel may be electrically conductive, making composite aerogel paper useful as an electrode for deionization in a flow through capacitor.

The carbon may be present in the electrode in a concentration of at least 60%, at least 70%, at least 80%, or at least 85% by weight of the dry electrode. The use of thermoplastic or viscoelastic material such as latex or a curable resin to form a monolith from powdered material is common. Examples of carbon layers that use polytetrafluoroethylene (PTFE) as binder material are the PACMM™ series (from Material Methods). One embodiment may comprise an active carbon fiber woven layer or carbon cloth, e.g. the Zorflex® range (from Chemviron Carbon).

An embodiment may comprise a carbon coating comprising: a binder, activated carbon and carbon black, which can be coated directly onto the current collector with a method described in PCT patent application publication number WO2009-062872 incorporated herein by reference, to form an electrode.

The electrode may comprise a current collector. The current collector may be made from an electrically conducting material. Suitable metal free materials are e.g. carbon, such as graphite, graphene, a graphite sheet or a carbon mixture with high graphite content. It is advantageous to use a metal free electrode and current collector, because metals are expensive and introduce a risk of corrosion. The current collector is generally in the form of a sheet. Such sheet is herein defined to be suitable to transport at least 33 amps/m² and up to 2000 amps/m². The thickness of a graphite current collector then typically becomes from 100 to 1000 micrometers or 200 to 500 micrometers.

### Spacer

The spacer material may comprise an inert type material, such as an open space synthetic material and can be any material made from e.g. a polymer, plastic or fiberglass. The spacer can be a porous or non-porous, woven or non-woven material. The spacer may be prepared from a material that is electrically insulating, but allows ion conductance. Suitable spacers are for example the Nitex® range or Petex® range (from Sefar), which are open mesh fabrics or filter fabrics, made from polyamide or polyethylene terephthalate.

Charge barrier layer

The flow through capacitor may comprise a charge barrier. The charge barrier comprises a membrane, selective for anions or cations, or certain specific anions or cations, which may be placed between the electrode and the spacer. The charge barrier may be applied to the high surface area electrode layer as a coating layer or as a laminate layer.

Suitable membrane materials may be homogeneous or heterogeneous. Suitable membrane materials comprise anion exchange and/or cation exchange membrane materials, desirably ion exchange materials comprising strongly dissociating anionic groups and/or strongly dissociating cationic groups. Examples of such membrane materials are Neosepta™ range materials (from Tokuyama), the range of PC-SA™ and PC-SK™ (from PCA GmbH), ion exchange membrane materials (from Fumatec), ion exchange membrane materials Ralex™ (from Mega) or the Excellion™ range of heterogeneous membrane material (from Snowpure).

### Stack

A FTC may comprise at least one repeating unit of:
anionic electrode comprising a current collector
optionally an anion exchange membrane as charge barrier
conventional FTC spacer
optionally a cation exchange membrane as charge barrier
cathode electrode comprising a current collector

Multiple repeating units may be used to build up a stack and the stacks may have a tray for positioning the stack within the apparatus to remove ions and to obtain equal distribution of pressure and water flow.

Typically the number of repeating units in a FTC stack, as found in practice, is limited by the number of electrode layers than can be practically bundled and connected to the connector. It is desirable that the number of repeating units in a FTC is at least 1, at least 5, at least 10, or at least 20. For practical reasons, the number of repeating units is generally not more than 200, not more than 150, not more than 100, or not more than 50.

The stack may be compressed at a pressure of less than 5 bar or less than 3 bar.

The stack may be provided with one or more, so called, floating electrodes. A floating electrode is an electrode not directly connected to a power source but receiving a polarized charge from one or more other electrodes in the stack which are connected to a power source or from one or more other floating electrodes. A floating electrode may be positioned parallel and in between master electrodes in the stack. An embodiment of the invention may connect the master electrodes in the stack to the power source. An advantage of using a floating electrode is that the voltages on the connector may be higher while the currents through the connector may be lower. Electrical loss due to the resistivity in the connector may be lowered significantly by using a floating electrode.

While specific embodiments of the invention have been described above, it may be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it may be apparent to one skilled in the art that modifications may be made to the invention as described without departing from the scope of the claims set out below.

1. A method of operating an apparatus to remove ions from water, the method comprising:
allowing water to flow in between a first and a second electrode of a capacitor;
charging the capacitor with a substantially constant electrical charge per unit time via a controller in order to attract ions into the electrodes;
releasing ions from the electrodes with a substantially constant electrical charge per unit time by releasing electrical charge from the capacitor via the controller, and during a subsequent charging of the capacitor, controlling the charging of the capacitor with the controller by applying an electrical charge which does not substantially exceed an amount of electrical charge released from the capacitor during releasing of ions from the electrode; and
measuring or calculating a quantity of electrical charge released from the capacitor and the amount of electrical charge charged to the capacitor with the controller.

2. The method according to claim 1, comprising:
measuring or calculating electrical charge that is charged to the capacitor;
comparing the measured or calculated electrical charge with a reference electrical charge; and
adjusting the electrical voltage on the capacitor in case the measured or calculated electrical charge is different from that of the reference electrical charge.

3. The method according to claim 1, comprising:
measuring a voltage difference over electrodes of the capacitor with a voltage measurement device; and
limiting the charging of the electrodes by controlling the voltage difference between the first and second electrodes so that it does not exceed a pre-set threshold value.

4. The method according to claim 1, comprising measuring time with a timer and providing this information to the controller.

5. The method according to claim 5, wherein the quantity of electrical charge released during the releasing of the ions is calculated from a measured current and the measured time during the releasing of the ions.

6. The method according to claim 1, further comprising registering the quantity of electrical charge that has been released from the capacitor during the releasing of the ions in a memory of the controller.

7. The method according to claim 6, wherein during charging of the capacitor in a subsequent charging of the capacitor, the quantity of charge that is applied to the capacitor is less than or equal to the quantity of charge which has been registered in the memory of the controller.

8. The method according to claim 1, comprising measuring a voltage over the capacitor as a function of time during the charging of the capacitor and the releasing of the ions and registering the voltage as a function of time in a memory of the controller.

9. The method according to claim 8, comprising measuring a voltage difference over the first and second electrodes of the capacitor as a function of time and comparing the voltage difference with the registered voltage difference as a function of time stored in the memory of the controller.

10. The method according to claim 1, wherein during charging of the capacitor, the controller calculates the electrical charge by multiplying a measured current during charging with a measured time from a timer.

11. An apparatus to remove ions, the apparatus comprising:
a first and a second electrode forming a capacitor;
a spacer to separate the electrodes of the capacitor and to allow water to flow in between the electrodes; and
a controller configured to control charging and discharging of the capacitor, the controller constructed and arranged to charge the capacitor with a substantially constant charging current and/or discharge the capacitor with a substantially constant discharge current, calculate a quantity of electrical charge released from the capacitor during discharging of the capacitor, and control electrical charge stored on the capacitor during a charging of the capacitor to not substantially exceed an amount of electrical charge released from the capacitor during a preceding discharging of the capacitor.

12. The apparatus according to claim 11, wherein the controller comprises:
a current measurement device configured to measure an electrical current applied to the capacitor; and
a processor configured to compare the measured current with a reference current value and if the measured current is different from the reference current value, adjust the voltage applied to the capacitor so that the measured current is substantially equal to the reference current value.

13. The apparatus according to claim 11, wherein the controller comprises:
a limiter configured to limit a voltage difference between the first and second electrodes of the capacitor so that the voltage difference does not exceed a pre-set threshold value;
a timer to measure time; or a memory in which the quantity of charge released during the releasing of ions is registered.

14. The apparatus according to claim 11, further comprising a voltage measuring device configured to measure a voltage difference over the first and second electrodes of the capacitor, and a memory configured to store a voltage over time profile and wherein the controller is configured to compare the measured voltage as a function of time with the stored voltage over time profile.

15. The apparatus according to claim 14, wherein the controller comprises a signaling device configured to signal an error signal if the result of the comparison between the measured voltage as a function of time and the stored voltage over time profile is larger than a threshold signal.

16. The apparatus according to claim 15, wherein the signaling device is configured to communicate with a remote control center.
